(19) United States
(12) Patent Application Publication
(10) Pub. No.: US 2018/0321182 A1
(43) Pub. Date: Nov. 8, 2018

(54) SENSOR ELEMENT AND METHOD FOR MANUFACTURING A SENSOR ELEMENT

(71) Applicant: Robert Bosch GmbH, Stuttgart (DE)

(72) Inventors: Hans-Joerg Renz, Leinfelden-Echterdingen (DE); Ingrid Gerner, Forchheim (DE); Jens Schneider, Leonberg (DE); Sabine Roesch, Ditzingen (DE); Sarah Richter, Stuttgart (DE)

(21) Appl. No.: 15/771,004

(22) PCT Filed: Nov. 3, 2016
(86) PCT No.: PCT/EP2016/076527

§ 371 Date: Apr. 25, 2018

(30) Foreign Application Priority Data
Nov. 10, 2015 (DE) 10 2015 222 108.3

(51) Int. Cl. G01N 27/407; G01N 15/06

(52) U.S. Cl. CPC G01N 27/4071; C04B 2235/00; G01N 27/4077; G01N 15/06

(57) ABSTRACT

A sensor element for an exhaust gas sensor includes a ceramic base body whose surface includes at least one surface region that is electrically insulating, the sensor element including at least one flat guide structure, which is electrically conductive, along the surface region of the base body. The guide structure is partially embedded in the base body in a direction perpendicular to the surface.

### CROSS-REFERENCE TO RELATED APPLICATIONS

The present application is the national stage of International Pat. App. No. PCT/EP2016/076527 filed Nov. 3, 2016, and claims priority under 35 U.S.C. § 119 to DE 10 2015 222 108.3, filed in the Federal Republic of Germany on Nov. 10, 2015, the content of each of which are incorporated herein by reference in their entireties.

### FIELD OF THE INVENTION

The present invention relates to a sensor element having an extended service life and a method for manufacturing such a sensor element.

### BACKGROUND

Sensor elements for exhaust gas sensors are already known from the related art. For example, DE 102006002111 A1 provides a sensor element for gas sensors for determining the concentration of particles in gas mixtures, in particular soot sensors, including at least one measuring system that is exposed to the gas to be determined, at least one heating element that is integrated into the sensor element, and at least one temperature measuring element that is integrated into the sensor element, the heating element being spatially situated within the sensor element between the measuring system and the temperature measuring element.

### SUMMARY

According to example embodiments of the present invention, partially embedding the guide structure in the base body in the direction perpendicular to the surface of the ceramic base body results in interlocking between the guide structure and the base body, and thus in a sustainably strong connection between the guide structure and the base body. If the sensor element is subjected to intense thermal, hydrothermal, and/or corrosive stress over its service life, the connection of the guide structure to the base body remains undiminished.

The guide structure being partially embedded in the direction perpendicular to the surface of the ceramic base body is understood here in particular to mean that only complete embedding is excluded, and that the guide structure is excluded from being situated solely on the unstructured surface of the base body. In particular, this is understood here to mean that, in the surface of the ceramic base body which otherwise has a macroscopic design, a microstructure is provided in which the guide structure is partially accommodated in the direction perpendicular to the surface of the ceramic base body.

The guide structure is an electrically conductive structure, i.e., in particular the guide structure is made of a material whose resistivity at room temperature is less than 0.5 ohm mm²/m.

Refinements of the present invention provide that there is a minimum level with which the guide structure penetrates into the ceramic base body, and that there is a minimum level with which the guide structure protrudes from the ceramic base body. In this regard, it can be provided that the guide structure penetrates, i.e., is embedded, with at least 10% of its height in the direction perpendicular to the surface. Additionally or alternatively, in this regard it can be provided that the guide structure penetrates, i.e., is embedded, by at most 90% in the direction perpendicular to the surface.

The guide structure can, for example, be embedded with up to one-half of its height in the base body, which can be understood in particular to mean a penetration between 30% and 70% of its height.

The sensor element can in particular be the sensor element of a particle sensor, which on its surface includes two comb-like, interlocking interdigital electrodes as a guide structure, which during proper use are essentially directly exposed to an exhaust gas.

Moreover, the present invention relates to a method for manufacturing a sensor element, in particular a sensor element according to the present invention. The method according to an example embodiment of the present invention provides for the manufacture of such a sensor element by sintering a ceramic precursor base body and a noble metal-containing precursor guide structure after the noble metal-containing precursor guide structure has been applied to the ceramic precursor base body and partially introduced into the precursor base body.

It is possible to carry out the application by imprinting. It is additionally or alternatively possible to carry out the introduction by pressing, for example during the imprinting. Alternatively, pressing can also be carried out subsequent to the imprinting, for example with the aid of a pressing device.

It is possible for the ceramic precursor base body to be made of an unsintered ceramic film, for example a ceramic film which contains aluminum oxide, yttrium-stabilized zirconium oxide (YSZ), cordierite, forsterite, or polycrystalline silicon, and additionally contains binder and solvent.

Furthermore, it can be provided that the ceramic precursor base body is made of the unsintered ceramic film as described above, on which in addition at least one insulating paste is flatly applied. In the process, the noble metal-containing precursor guide structure is applied to and partially introduced into the at least one insulating paste.

It is provided in particular that the noble metal-containing precursor guide structure has a higher viscosity, i.e., is harder, than the at least one insulating paste. This ensures that the noble metal-containing precursor guide structure can be partially introduced into the insulating paste with little effort and with high precision.

It can be provided that the ceramic precursor base body is made of the unsintered ceramic film as described above, on which in addition a second insulating paste and subsequently a first insulating paste are flatly applied in succession. The precursor guide structure is in turn applied to the insulating pastes. The precursor guide structure is preferably pressed, in particular partially pressed, into the outer, first insulating paste.

It can be provided that the first insulating paste and the second insulating paste are different with regard to their physical, chemical, and rheological properties. It can thus be advantageous when the second insulating paste, which comes to rest between the ceramic film and the first insulating paste, fulfills the function of an adhesive layer. For this purpose, it can be provided that the second insulating paste has a higher solvent content than the first insulating paste, so that partial solubilization of the ceramic film takes place. Additionally or alternatively, it can be provided that the second insulating paste has a higher content of fine-particle, and thus sinter-active, zirconium oxide and/or a higher content of coarse-particle aluminum oxide than the first insulating paste, which in turn has adhesion-improving effects.

It can also advantageously be provided that the first insulating paste is softer, i.e., has a lower viscosity, than the second insulating paste. This facilitates the in particular precise pressing of the precursor guide structure significantly.

The pressing of the precursor guide structure into the precursor base body can always be assisted in that, prior to application of the precursor guide structure, the precursor base body undergoes structuring with structures into which the precursor guide structure is subsequently partially introduced. The structures can be microstructures, i.e., can have structure sizes that are smaller than 150 μm in one spatial direction or in two spatial directions.

When reference is made to viscosities within the scope of the present patent application, these have been ascertained with a rotational viscometer at a shear rate of 30/s and a temperature of 20° C. When reference is made to tan delta values within the scope of the present patent application, these loss factors have been ascertained at a shear stress of 500 Pa.

The present invention is explained in greater detail with reference to the figures.

### BRIEF DESCRIPTION OF THE DRAWINGS

FIGS. 1a-1c show a sensor element of a particle sensor according to the related art in an exploded view and in an enlarged longitudinal section.

FIGS. 2a-2c show modifications of the sensor element from FIG. 1 according to various example embodiments of the present invention.

FIGS. 3a and 3b show the device according to another example embodiment of the present invention.

FIGS. 4-6 show examples of the manufacture of a sensor element according to an example embodiment of the present invention.

### DETAILED DESCRIPTION

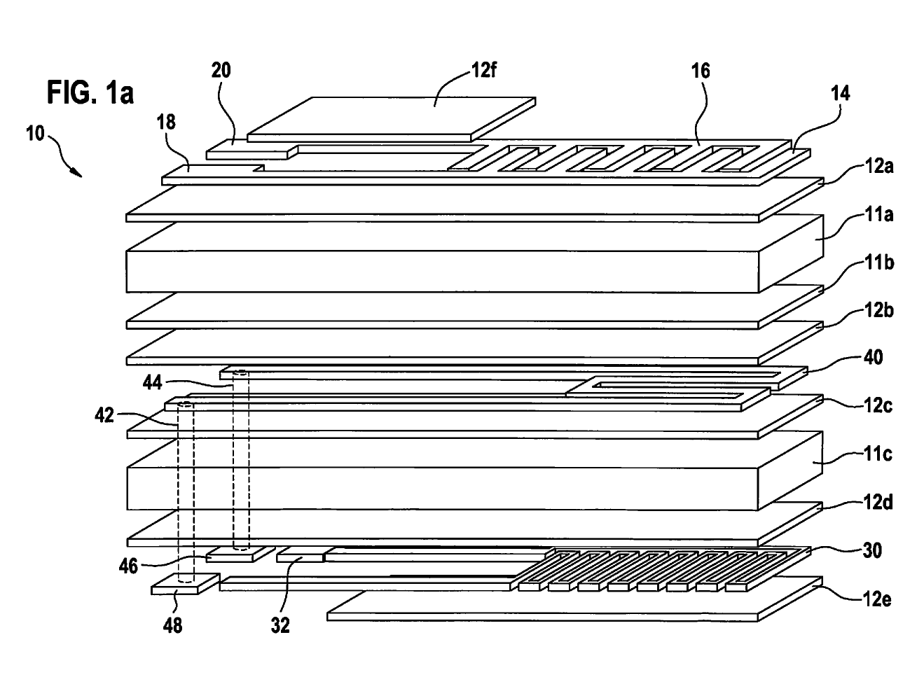

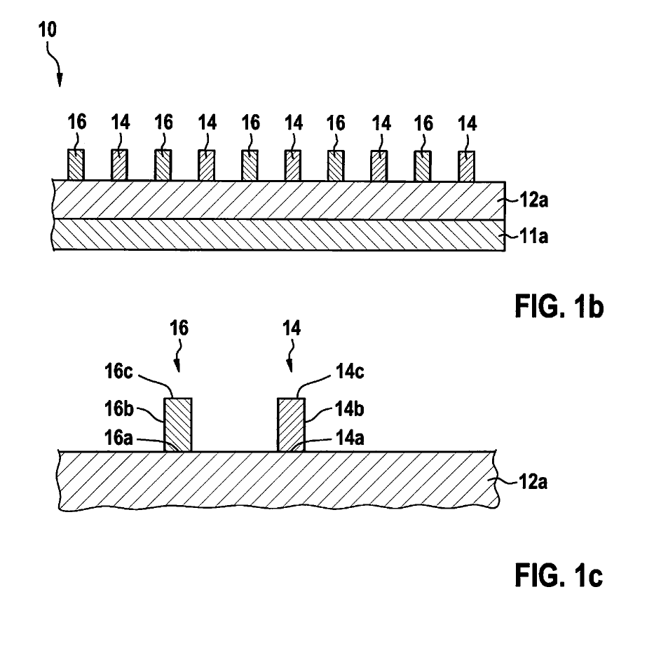

FIG. 1a illustrates a basic structure of a ceramic sensor element 10 of a particle sensor in an exploded view. Ceramic sensor element 10 is used to determine a particle concentration, for example the soot concentration, in a gas mixture surrounding sensor element 10. Sensor element 10 includes, for example, a plurality of oxygen ion-conducting solid electrolyte layers 11a, 11b, and 11c. Solid electrolyte layers 11a and 11c are designed as ceramic films and form a planar ceramic body. They are made of an oxygen ion-conducting solid electrolyte material, for example ZrO2 stabilized or partially stabilized with Y2O3, Ce, or Sc.

In contrast, solid electrolyte layer 11b is produced with the aid of screen printing of a paste-like ceramic material on solid electrolyte layer 11a, for example. The same solid electrolyte material of which solid electrolyte layers 11a, 11c are made is preferably used as the ceramic component of the paste-like material.

In addition, the sensor element includes, for example, a plurality of electrically insulating ceramic layers 12a, 12b, 12c, 12d, 12e, and 12f. Layers 12a through 12f are likewise produced with the aid of screen printing of a paste-like ceramic material on solid electrolyte layers 11a, 11b, 11c, for example. Aluminum oxide, for example, is used as the ceramic component of the paste-like material, since it has an essentially constant, high electrical resistance over a long period of time, even under thermal cycling.

The integrated form of the planar ceramic body of sensor element 10 is produced by laminating together the ceramic films imprinted with solid electrolyte layer 11b, with functional layers, and with layers 12a through 12f, and subsequently sintering the laminated structure in a manner known per se.

Sensor element 10 also includes a ceramic heating element 40 which is designed in the form of an electrical resistance conductor track and used for heating sensor element 10 in particular to the temperature of the gas mixture to be determined, or burning off the soot particles that accumulate on the large surfaces of sensor element 10. The resistance conductor track is preferably made of a cermet material, preferably as a mixture of platinum or a platinum metal with ceramic portions, for example aluminum oxide. The resistance conductor track is also preferably designed in the form of a meander, and includes vias 42, 44 as well as electrical terminals 46, 48 at both ends. The heat output of heating element 40 can be appropriately regulated by applying a corresponding heating voltage to terminals 46, 48 of the resistance conductor track.

For example, two measuring electrodes 14, 16 that are preferably designed as interlocked interdigital electrodes are applied to a large surface of sensor element 10. The use of interdigital electrodes as measuring electrodes 14, 16 advantageously allows a particularly accurate determination of the electrical resistance or the electrical conductivity of the surface material present between measuring electrodes 14, 16. Contact areas 18, 20 are provided for contacting measuring electrodes 14, 16 in the area of an end of the sensor element facing away from the gas mixture. The supply line areas of electrodes 14, 16 are preferably shielded from the influences of a gas mixture surrounding sensor element 10 by a further electrically insulating ceramic layer 12f.

In addition, a porous layer, not illustrated for reasons of clarity, which shields measuring electrodes 14, 16 in their interlocked area from direct contact with the gas mixture to be determined can be provided on the large surface of sensor element 10 provided with measuring electrodes 14, 16. The layer thickness of the porous layer is preferably greater than the layer thickness of measuring electrodes 14, 16. The porous layer preferably has an open porous design, the pore size being selected in such a way that the particles to be determined in the gas mixture can diffuse into the pores of the porous layer. The pore size of the porous layer is preferably in a range of 2 μm to 10 μm. The porous layer is made of a ceramic material that is preferably similar to the material of layer 12a or corresponds to same, and that can be produced with the aid of screen printing. The porosity of the porous layer can be appropriately set by adding pore builders to the screen printing paste.

A voltage is applied to measuring electrodes 14, 16 during operation of sensor element 10. Since measuring electrodes 14, 16 are situated on the surface of electrically insulating layer 12a, this initially results in essentially no current flow between measuring electrodes 14, 16.

If a gas mixture flowing around sensor element 10 contains particles, in particular soot, these particles accumulate on the surface of sensor element 10. Due to the open-pore structure of the porous layer, the particles diffuse through the porous layer to the immediate proximity of measuring electrodes 14, 16. Since soot has a certain electrical conductivity, when there is sufficient loading of the surface of sensor element 10 or of the porous layer with soot, this results in an increasing current flow between measuring electrodes 14, 16, which correlates with the extent of the loading.

If a voltage is now applied to measuring electrodes 14, 16 and the electric current that occurs between measuring electrodes 14, 16 is ascertained, a conclusion can be drawn concerning the accumulated particle mass. The concentration of all particles in a gas mixture that influence the electrical conductivity of the ceramic material situated between measuring electrodes 14, 16 is detected with this measuring method.

FIG. 1b shows the upper levels of the distal end section of sensor element 10 from FIG. 1a in an enlarged longitudinal section. It is apparent that in sensor element 10 known from the related art, situated on solid electrolyte layer 11a is an electrically insulating ceramic layer 12a, on which measuring electrodes 14, 16 are situated. Measuring electrodes 14, 16 rest on electrically insulating ceramic layer 12a, i.e., they contact the latter only with their base surfaces 14a, 16a, while their lateral surfaces 14b, 16b and their surfaces 14c, 16c pointing away from electrically insulating ceramic layer 12a are not in contact with electrically insulating ceramic layer 12a. See FIG. 1c, which shows the upper levels of the distal end section of sensor element 10 from FIG. 1a with even greater enlargement.

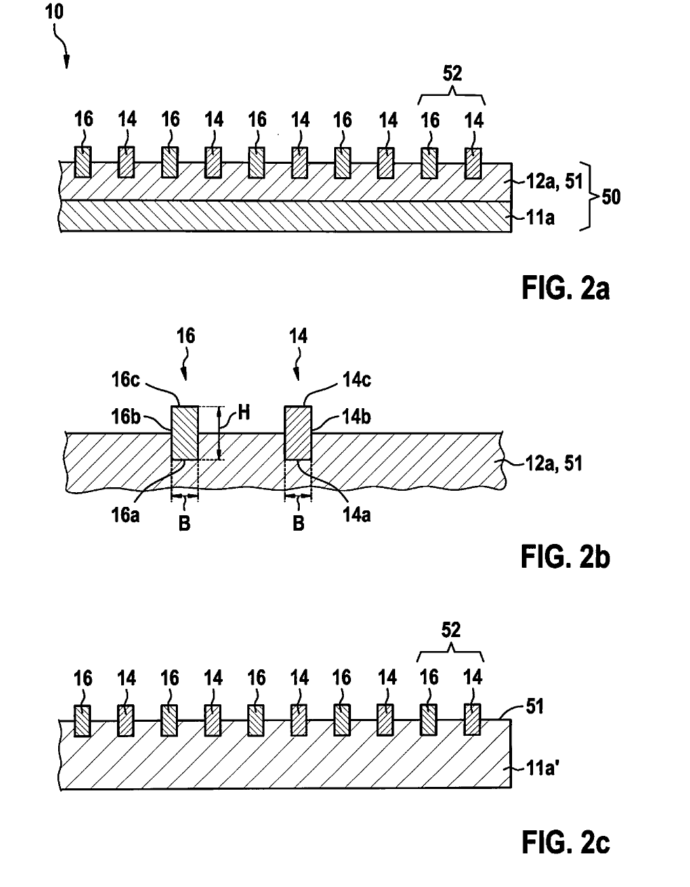

A first example embodiment of a sensor element 10 according to the present invention is described below. FIGS. 2a and 2b schematically show the design of a distal end section of a sensor element 10 that is modified compared to FIG. 1. For this sensor element 10, an electrically insulating ceramic layer 12a made of aluminum oxide is situated on a solid electrolyte layer 11a made of zirconium oxide stabilized with yttrium, cerium, or scandium (YSZ). Solid electrolyte layer 11a and electrically insulating ceramic layer 12a together form base body 50 of sensor element 10. Surface 51 of the base body is formed by electrically insulating ceramic layer 12a. Sensor element 10 once again includes two measuring electrodes 14, 16, which in the example are made predominantly of platinum and are thus electrically conductive, and which together form a guide structure 52. Measuring electrodes 14, 16 have a height H that is perpendicular to surface 51 of sensor element 10, i.e., vertical in FIG. 2, and is 15 μm in the example. Measuring electrodes 14, 16 have a width B that is in parallel to surface 51 of sensor element 10, i.e., extending from left to right in FIG. 2, and is 100 μm in the example.

Measuring electrodes 14, 16 are partially embedded in base body 50, in the present case partially embedded in electrically insulating layer 12a, in the direction perpendicular to surface 51 of base body 50, and are thus interlocked, in a manner of speaking, with the base body, thus in the present case with electrically insulating layer 12a. Base surfaces 14a, 16a of measuring electrodes 14, 16 are thus in contact with base body 50, while lateral surfaces 14b, 16b of measuring electrodes 14, 16 are partially accommodated (up to one-half here) in base body 50, and partially protrude (by one-half here) from base body 50. Surfaces 14c, 16c of measuring electrodes 14, 16 pointing away from ceramic base body 50 are not in contact with base body 50.

In addition, an electrically non-conductive porous layer, not illustrated for reasons of clarity, which shields measuring electrodes 14, 16 in their interlocked area from direct contact with the gas mixture to be determined can be provided on the large surface of sensor element 10 provided with measuring electrodes 14, 16. The layer thickness of the porous layer is preferably greater than the layer thickness of measuring electrodes 14, 16. The porous layer preferably has an open porous design, the pore size being selected in such a way that the particles to be determined in the gas mixture can diffuse into the pores of the porous layer. The pore size of the porous layer is preferably in a range of 2 μm to 10 μm.

Guide structure 52, as described above, can be measuring electrodes 14, 16 of a particle sensor designed as interdigital electrodes. Alternatively, guide structure 52 can also be the resistance track of a temperature sensor and/or of an electrical heater. Of course, guide structure 52 can also be any other conductor track included by sensor element 10.

In a first modification of the first exemplary embodiment, instead of solid electrolyte layer 11a, a layer 11a′ made of some other material, for example polycrystalline silicon, aluminum oxide, forsterite, or cordierite, is present.

In a second modification of the first exemplary embodiment (see FIG. 2c), likewise instead of solid electrolyte layer 11a, a layer 11a′ made of some other material, for example an electrically insulating material such as aluminum oxide, forsterite, or cordierite, is present. Moreover, electrically insulating ceramic layer 12a is dispensed with. Guide structure 52 is thus directly interlocked with layer 11a′ made of a material, for example an electrically insulating material such as aluminum oxide, forsterite, or cordierite, i.e., partially embedded in same.

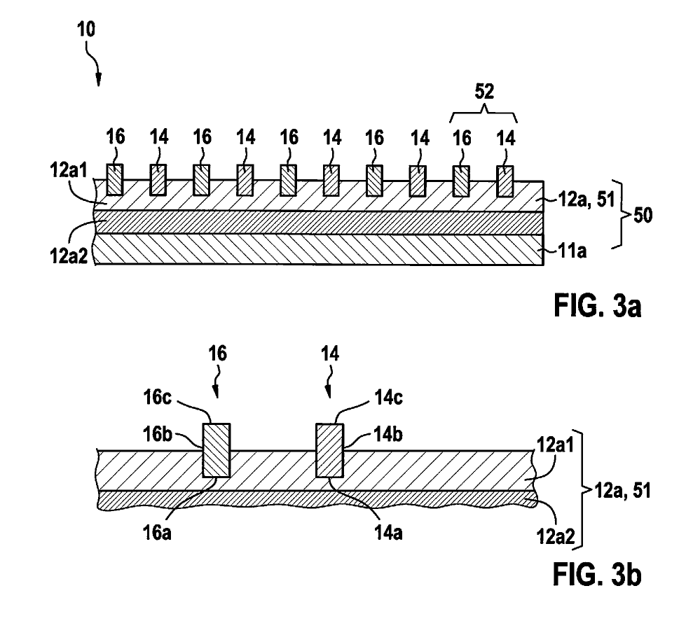

A second exemplary embodiment differs from the first exemplary embodiment in that electrically insulating ceramic layer 12a is made up of two layers situated one above the other, namely, a second sublayer 12a2 and a first sublayer 12a1 situated on second sublayer 12a2. Guide structure 52 is embedded only in first sublayer 12a1. The second exemplary embodiment is illustrated in FIG. 3.

First sublayer 12a1 differs from second sublayer 12a2 with regard to its chemical and physical properties. Thus, second sublayer 12a2 has a higher pore content than first sublayer 12a1. For example, in an example embodiment, second sublayer 12a2 has a pore content of 5 vol % to 15 vol %, while first sublayer 12a1 has a pore content of 2 vol % to 8 vol %. The pore content of second sublayer 12a2 can, for example, be approximately twice the pore content of first sublayer 12a1.

In addition, second sublayer 12a2 has a content of yttrium-stabilized zirconium dioxide (YSZ), for example 2-10 weight percent, which is greater than a content of zirconium dioxide stabilized with yttrium, Ce, or Sc (YSZ), which first sublayer 12a1 optionally contains. However, first sublayer 12a1 is preferably made of pure aluminum oxide.

It is also provided that the zirconium dioxide contained in second sublayer 12a2 has a grain size (d50) which is smaller than 1 μm, and which is smaller than the grain size (d50) of the zirconium oxide optionally contained in first sublayer 12a1.

It is also provided that the aluminum oxide contained in second sublayer 12a2 is α-aluminum oxide.

The aluminum oxide contained in second sublayer 12a2 has a comparatively large grain size. Thus, 2-5 weight percent of the aluminum oxide contained in second sublayer 12a2 can have a grain size (d50) of larger than 3 μm. In contrast, the proportion of such coarse-grain aluminum oxide, in particular the portion of aluminum oxide grains larger than 3 μm, in first sublayer 12a1 is less.

Guide structures 52 described in the exemplary embodiments are highly insulated compared to other electrically conductive structure elements, for example heaters and/or temperature measuring devices, of sensor element 10, which means that an electrical resistance that forms between guide structures 52 and the other electrically conductive structure elements is at least 1 megaohm at 25° C. and/or at least 10 kiloohms at 850° C.

A description of how a sensor element 10 can be manufactured according to the present invention is described below by way of example.

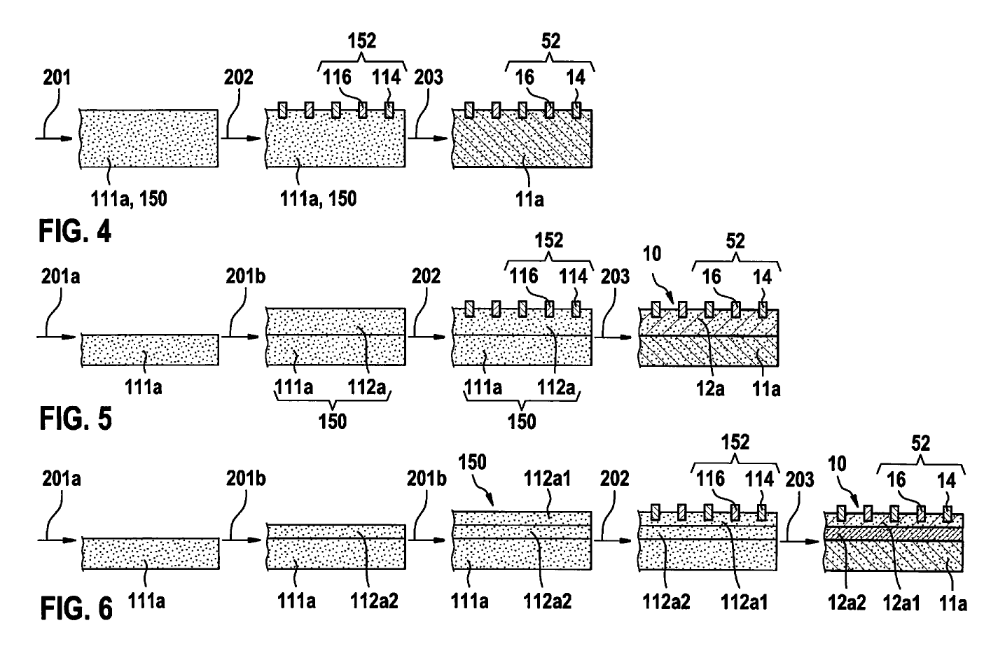

In a first example, as is apparent in FIG. 4, a precursor base body 150 made solely of an unsintered ceramic film 111a, for example an aluminum oxide ceramic film or a film containing cordierite, forsterite, or polycrystalline silicon, is provided in a first method step 201.

Unsintered ceramic film 111a is imprinted with a precursor guide structure 152, made up of two precursor measuring electrodes 114, 116, in a screen printing process in a second method step 202. Precursor guide structure 152 is applied in the form of a platinum-containing screen printing paste. The platinum-containing screen printing paste has a relatively high viscosity, and is imprinted with a high enough pressure that it is pressed partially, up to one-half in the example, into unsintered ceramic film 111a during the imprinting.

As an alternative to effectuating the pressing directly during the imprinting, the pressing can be carried out subsequent to the imprinting, for example with the aid of a separate pressing device. It is also possible to create structures, preferably microstructures, prior to the imprinting in the ceramic film 111a, and to press precursor guide structure 152 into these structures.

Sintering, which transforms precursor guide structure 152 and precursor base body 150 into finished sensor element 10, takes place in a third method step 203. The sintering can take place, for example, for several hours at a temperature above 1200° C.

Of finished sensor element 10, only the upper layers of the distal end section (facing the exhaust gas) are illustrated in the right portion of FIG. 4, i.e., a layer 11a made of an insulating material, for example aluminum oxide, forsterite, or cordierite, and measuring electrodes 14, 16, which together form guide structure 52.

In a second example (see FIG. 5), first substep 201a of first method step 201 starts with an unsintered ceramic film 111a, which once again is made of aluminum oxide, forsterite, or cordierite, for example, or also of a solid electrolyte material, for example yttrium-stabilized zirconium dioxide (YSZ), or of polycrystalline silicon.

This unsintered ceramic film 111a is imprinted over its entire surface with an insulating paste 112a, for example in a screen printing process, in second substep 201b of first method step 201. Insulating paste 112a includes aluminum oxide powder, for example, and is made workable by adding a binder and a solvent, for example polyvinyl butyral and butyl carbitol, respectively.

Second method step 202 takes place as in the first example, with the condition that precursor guide structure 152 is imprinted on insulating paste 112a and pressed into same. For this purpose, it has proven to be advantageous when precursor guide structure 152, in the present case the platinum-containing screen printing paste, has a higher viscosity than insulating paste 112a. For example, the viscosity of insulating paste 112a may be in the range between 30 Pas and 100 Pas, while the viscosity of precursor guide structure 152 may be in the range between 100 Pas and 600 Pas.

The final sintering takes place in third method step 203 as described above.

A third example illustrated in FIG. 6 provides that, in a modification of the second example, two insulating pastes 112a2, 112a1 are applied one above the other in succession to unsintered ceramic film 111a in second substep 201b of first method step 201.

A second insulating paste 112a2 is initially imprinted on unsintered ceramic film 111a. First insulating paste 112a1 is subsequently imprinted on second insulating paste 112a2. First insulating paste 112a1 and second insulating paste 112a2 can be identical with regard to their composition and their physical and chemical properties, but in this example they differ as follows. Second insulating paste 112a2 has a lower content of ceramic powder (aluminum oxide here) than first insulating paste 112a1. Accordingly, second insulating paste 112a2 has a higher content of binder (polyvinyl butyral here) and of solvent (butyl carbitol here) than first insulating paste 112a1. Additionally, the viscosity of second insulating paste 112a2 is higher than the viscosity of first insulating paste 112a1.

In this example, the layer thicknesses with which first insulating paste 112a1 and second insulating paste 112a2 are applied are the same. In addition, the tan delta values of the two insulating pastes 112a1, 112a2 are the same in this example.

30-80 weight percent of second insulating paste 112a2 is made up of ceramic powder (aluminum oxide here). Its viscosity is 30 Pas-100 Pas. Its tan delta value is between 1.2 and 100. It is applied in a thickness of 8 μm-25 μm.

50-80 weight percent of first insulating paste 112a1 is made up of ceramic powder (aluminum oxide here). Its viscosity is 10 Pas-60 Pas. Its tan delta value is between 1.2 and 100. It is applied in a thickness of 8 μm-25 μm.

Second insulating layer 11a2 of sensor element 10 has the function of an adhesive layer which improves the adherence of first insulating layer 11a1 and guide structure 52. For this purpose, 2 to 10 weight percent of fine-particle (d50 less than 1 μm) zirconium dioxide stabilized with yttrium, cerium, or scandium as a sinter-active adhesion promoter is mixed with second insulating paste 112a2. In addition, for this purpose 2 to 5 weight percent of coarse-particle (d50 greater than 3 μm) α-aluminum oxide is mixed with second insulating paste 112a2.

Second method step 202 takes place as in the second example, with the condition that precursor guide structure 152 is imprinted on first insulating paste 112a1 and pressed into same. For this purpose, it has proven to be advantageous when precursor guide structure 152, in the present case the platinum-containing screen printing paste, has a higher viscosity than first insulating paste 112a1. For example, the viscosity of precursor guide structure 152 can be in the range between 100 Pas and 600 Pas. The noble metal (platinum here) content of the platinum-containing screen printing paste is 60 to 90 weight percent. Ethylcellulose as binder and terpineol as solvent are added to the platinum-containing screen printing paste. The tan delta value of the platinum-containing screen printing paste is between 0.7 and 1.3, and is less than the tan delta value of first insulating paste 112a1. The platinum-containing screen printing paste is applied with a thickness of 5 μm-15 μm.

The subsequent sintering in third method step 203 takes place as described above.

The applicant has carried out robustness tests with the sensor elements described in the exemplary embodiments, as described in detail in German Patent application DE 10 2015 206 995 A1. Tests were carried out in such a way that in particular the parameters of the tests were selected so that a high proportion of conventional sensor elements (see FIG. 1) were damaged. In particular, detachments of guide structure 52 from base body 50 of sensor elements 10 occurred.

In contrast, with sensor elements 10 according to the present invention, it was even possible to carry out the same tests multiple times in succession without damage occurring to sensor elements 10 according to the present invention.

1-14. (canceled)

15. A sensor element for an exhaust gas sensor, the sensor element comprising:
a ceramic base body whose surface includes a surface region that is electrically insulating; and
along the surface region of the base body, at least one flat guide structure that is electrically conductive and is partially embedded in the base body in a direction perpendicular to the surface.

16. The sensor element of claim 15, wherein the guide structure is embedded by 10% to 90% in the base body in the direction perpendicular to the surface.

17. The sensor element of claim 15, wherein the surface region is made entirely of aluminum oxide.

18. The sensor element of claim 15, wherein the surface region contains predominantly aluminum oxide.

19. The sensor element of claim 15, wherein the surface region is formed by an electrically insulating layer, and the base body is made of a solid electrolyte material.

20. The sensor element of claim 19, wherein the solid electrolyte material is yttrium-stabilized zirconium dioxide (YSZ).

21. The sensor element of claim 15, wherein the surface region is formed by an electrically insulating layer that is made up of a first sublayer and a second sublayer that is situated on, and has a lower pore content than, the first sublayer.

22. The sensor element of claim 15, wherein the at least one guide structure in the surface region has a height, in a direction locally perpendicular to the surface, of no greater than 15 μm, and/or has a width in a direction locally in parallel to the surface of no greater than 100 μm.

23. The sensor element of claim 22, wherein the at least one guide structure in the surface region has a width, in a direction locally in parallel to the surface of no greater than 100 μm.

24. The sensor element of claim 15, wherein the at least one guide structure in the surface region has a width in a direction, locally in parallel to the surface, of no greater than 100 μm.

25. The sensor element of claim 15, wherein the exhaust gas sensor is a particle sensor, and the guide structure is at least one interdigital electrode.

26. The sensor element of claim 15, wherein the exhaust gas sensor is a particle sensor, and the guide structure is a resistance track of a temperature sensor.

27. A method for manufacturing a sensor element, the method comprising:
providing an unsintered ceramic precursor base body;
applying a noble metal-containing precursor guide structure to the ceramic precursor base body in a manner by which the precursor guide structure is partially embedded in the precursor base body;
sintering the ceramic precursor base body and the noble metal-containing precursor guide structure to form:
a ceramic base body; and
an electrically conductive guide structure of the sensor element (a) arranged along an electrically insulating surface region that is at a surface of the ceramic base body and (b) partially embedded in the base body in a direction perpendicular to the surface.

28. The method of claim 27, wherein the application of the precursor guide structure includes introducing 10%-90% of a height of the precursor guide structure into the precursor base body.

29. The method of claim 27, wherein the provision of the unsintered ceramic precursor base body includes:
providing at least one unsintered ceramic film; and
flatly applying at least one insulating paste to the at least one ceramic film.

30. The method of claim 29, wherein the flat application of the at least one insulating paste to the at least one unsintered ceramic film includes:
flatly applying a first insulating paste to the at least one unsintered ceramic film; and
subsequently applying to the first insulating paste a second insulating paste that has at least one of a lower viscosity and a higher solids content than the first insulating paste.

31. The method of claim 30, wherein the first insulating paste has a higher content of at least one of fine-particle zirconium oxide and coarse-particle aluminum oxide than the second insulating paste.

32. The method of claim 27, wherein the application of the noble metal-containing precursor guide structure takes place by imprinting a noble metal-containing paste that has a higher viscosity than the precursor base body in an area in which the noble metal-containing paste is applied.

33. The method of claim 27, wherein the sintering takes place at a temperature above 1200° C.

34. The method of claim 27, wherein the sintering takes place for longer than one hour.
